(19) United States
(12) Patent Application Publication
(10) Pub. No.: US 2003/0005438 A1
(43) Pub. Date: Jan. 2, 2003

(54) Tailoring a broadcast schedule based on storage area and consumer information

(76) Inventors: Regis J. Crinon, Camas, WA (US); David W. Doerner, Beaverton, OR (US)

Correspondence Address: James H. Salter, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/895,744

(22) Filed: Jun. 29, 2001

(51) Int. Cl. H04N 7/025; H04N 7/10; G06F 3/00; H04N 5/445; G06F 13/00

(52) U.S. Cl. 725/34; 725/46

(57) ABSTRACT

An apparatus, computer readable medium, and method includes selecting and scheduling, substantially automatically, multimedia-content to be broadcast to a consumer, based on information obtained from at least one of the consumer and a storage area.

### FIELD OF INVENTION

This invention relates generally to tailoring a broadcast schedule for transmission of multimedia content over a communication channel, and more particularly to selecting the broadcast schedule based on storage area and consumer information

### BACKGROUND

Different methods of supplying television content to a consumer have been employed by cable television (CATV) companies and satellite television (SATV) providers, using the ultrahigh frequency (UHF) and very high frequency (VHF) communication bands. These methods suffer from bandwidth limitations and an inability to tailor the content of a broadcast to the individual taste of the consumer. Programming content is predetermined by the CATV provider and broadcasted to the consumers that subscribe to the service. Multiple levels of service are usually available, where more channels of programming are available for an increasing financial charge to the consumer. The consumer can change the level of service subscribed. However, the content of the level of service is usually the same at a given time of day. Thus, the consumer cannot change the content of the level of service and must accept what is broadcasted at a particular time. A fixed number of channels are available, based on a bandwidth of a system employed, which then sets the breadth of the content that will be available to all the subscribers of the service.

A variation on CATV service that introduced a measure of consumer choice is Pay per View™, which allows a subscriber to pay for a view of a movie or a particular event broadcast at a particular time, such as a sporting event. The subscriber could choose to pay for and watch a particular movie at the time the movie was broadcast. In this manner, subscribers may choose from a given number of movies allocated to the Pay per View™ channels on the CATV or SATV system.

CATV providers have also introduced a server into a head-end of the CATV system as shown in FIG. 1. FIG. 1 Is a representation of a CATC system 100 that provides simultaneous viewing of movies by consumers indicated in FIG. 1, as individual homes. With reference to FIG. 1, the CATV head-end 102 may contain three or four hundred movies indicated by movies 104. A cable network 106 is connected to a plurality of homes indicated as home 108 through home 122. In such a system bandwidth is allocated for simultaneous viewing of movies selected by each home. For example, a home 114 has selected a movie 124 to view. The CATV system allocates bandwidth to allow the home 114 to watch the movie 124. At the same time, the home 122 may have selected a movie 126 to view. The CATV system allocates bandwidth to allow the home 122 to view the movie 126 concurrently with the home 114 viewing the movie 124. Bandwidth allocated in this way by the CATV system is not available for the other uses until the home is finished viewing the selected movie. The simultaneous allocation of bandwidth to accommodate the individual homes viewing the different movies presents limitations on the system design.

The bandwidth in the CATV system is finite and the system will only be able to service a finite number of requests for different movies in the example given above. Another example of a limitation, in this kind of system, is that the system has to be designed to accommodate the peak usage. Peak usage might occur at 9 PM Saturday night. Usage is not constant and varies with time of day and the day of the week. Therefore, bandwidth is often underutilized during periods of light use. Periods of light use may occur at 3 AM on a weekday when most people are sleeping instead of viewing movies.

These prior art systems require the consumer to watch the programming in real time, as the broadcast is occurring. Consumers can eliminate the real time requirement by using a video tape recorder to tape a program while it was being received. The videotape of the program could then be played at a later time.

Following videotape recorders came hard drive storage-based receiver devices, which allowed the consumer to store the digital television broadcast on the hard disk as data. These devices are manufactured and sold under the trade names TIVO™ and UltimateTV™. Hard drive storage-based receiver devices such as these provide similar functionality as that of their predecessors, videotape recorders. The hard drive storage devices attached to the previously described CATV systems suffer from the same restrictions in consumer choice of content since all of these prior art systems are designed to receive streaming video from the real time broadcast.

Both the videotape recorder and the hard drive storage provided by TIVO™ and UltimateTV™ need to be managed by the consumer since the storage capacities are finite. Management by the consumer consists of deciding what to save and what to erase from storage.

What is needed therefore, is a system that allows the consumer to select multimedia-content in such a manner that does not tax the bandwidth of the delivery system. What is also needed is a method of providing transparent management of the storage device associated with the television receiver so that the consumer is decoupled from the task of management. What is also needed is a method that leads to scheduling delivery of multimedia content in an optimal way and consistent way over time. Additionally, there is a need for a method of selecting multimedia-content for the consumer so that the multimedia-content available to the consumer is more closely in line with the consumer's interests.

### BRIEF DESCRIPTION OF THE DRAWINGS

FIG. 1 is a representation of a cable television system (CATV) that allows simultaneous viewing of movies by individual homes.

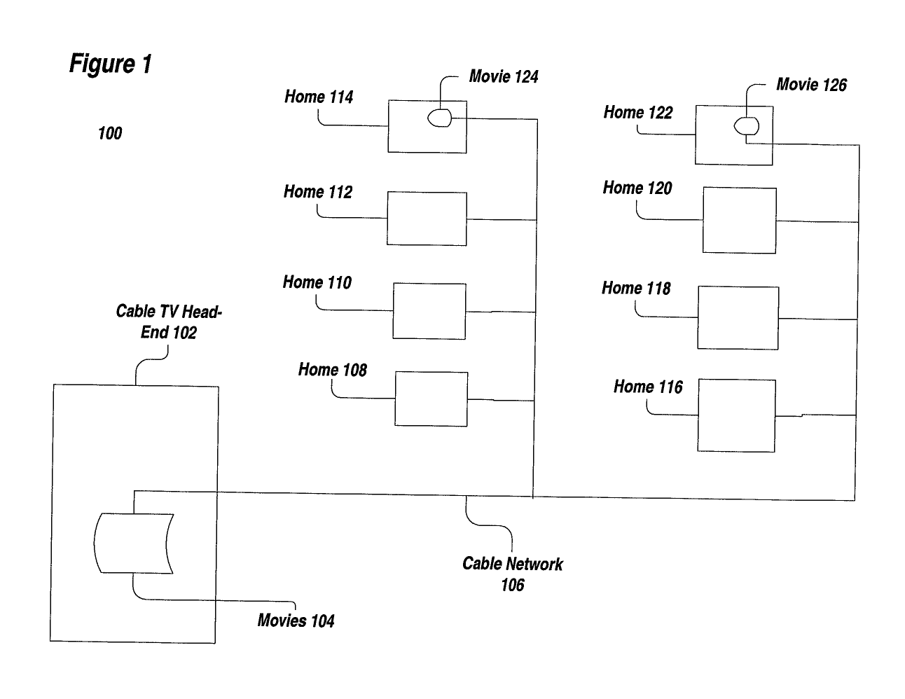

FIG. 2 is a schematic representation of the invention.

FIG. 3 embodies four major processes that combine to select and adjust a multimedia-content of a consumer's storage area.

FIG. 4 lists six criteria that may be used to select a multimedia-content.

FIG. 5 is a histogram displaying information on the multimedia-content of the consumer's storage area or the aggregate storage area of a plurality of consumers, as a function of time.

FIG. 6 depicts opportunistic data insertion (ODI) as applied to a transmission of data used in a digital television (DTV) broadcast.

FIG. 7 shows a storage area for multimedia-content that has been categorized.

FIG. 8 is a flow diagram displaying a method for managing multimedia-content on a storage area.

FIG. 9 displays two ways of configuring a transmission of a multimedia-content that enables the multimedia-content to be customized for each consumer.

### DETAILED DESCRIPTION

In the following detailed description of embodiments of the invention, reference is made to the accompanying drawings in which like references indicate similar elements, and in which is shown by way of illustration, specific embodiments in which the invention may be practiced. These embodiments are described in sufficient detail to enable those skilled in the art to practice the invention. The following detailed description is, therefore, not to be taken in a limiting sense, and the scope of the invention is defined only by the appended claims.

A system and method that selects a multimedia-content to be broadcast to a consumer, based on information obtained from the consumer, is disclosed. The system and method may be employed at various levels. In one embodiment, a high level of implementation may be to select multimedia-content that may be broadcast to all of the consumers. In another embodiment, a lower level of implementation may be to select the multimedia-content for a specific consumer. Additionally, the invention may be tailored to any level or combinations of levels so described.

Consumer, as used in this content, refers to one who listens to, views, receives, enjoys, or is in some way connected with the reception of the multimedia-content broadcasted. Consumer may also refer to one who pays for the reception of the multimedia content but consumer may also refer to one who does not pay for the reception of the multimedia-content.

It is anticipated that many different kinds of subject matter may constitute multimedia-content. For example, multimedia-content may be a movie or it may be a prizefight, or a beauty contest, or any other subject matter that may be of interest to the consumer. Additionally, multimedia content may be audio media, a combination of audio and video, full motion video or data that may or may not be configured as full motion video. In general multimedia content is anticipated to include anything that may be perceived by the senses.

### System Level Overview

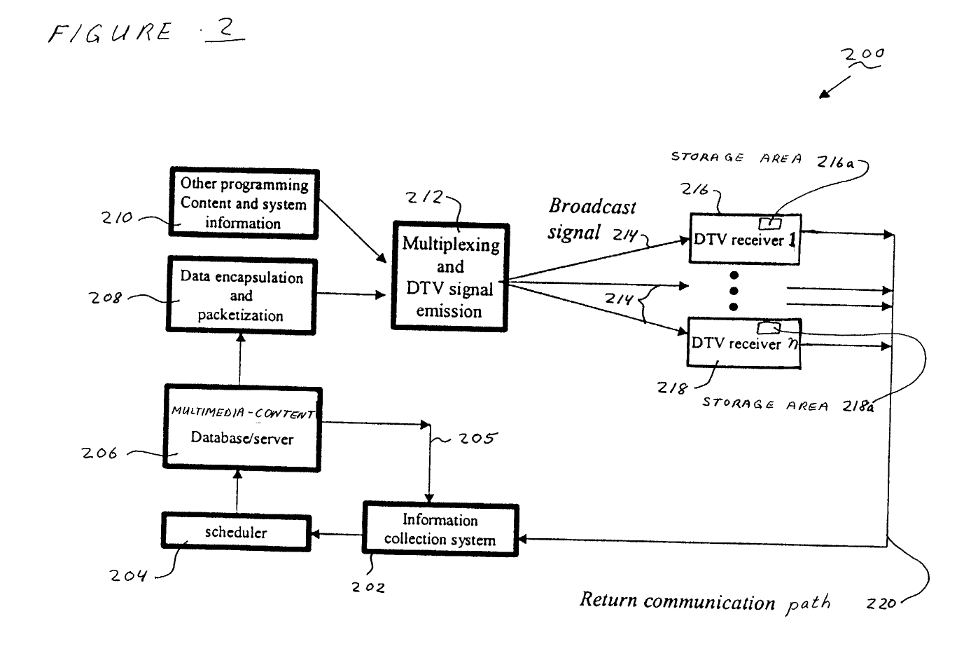

In one embodiment, FIG. 2 is a schematic representation of the invention, depicting a selection system for multimedia-content 200, as applied to a general number n, of digital television (DTV) receivers. With reference to FIG. 2, a DTV receiver 216 has a storage area 216a. There may be a general number of DTV receivers n, as previously mentioned, where a DTV receiver 218 represents the n^{th} such DTV receiver having a storage area 218a. The DTV receivers receive a broadcast signal 214, which contains multimedia-content. Broadcast signal 214 may be provided to the DTV receivers by any of the methods that are will known in the art. In one embodiment, broadcast signal 214 can propagate in a coaxial cable or an optical fiber transmission line to the DTV receiver. In another embodiment, broadcast signal 214 can be broadcast from a satellite and be received by a satellite dish receiver configured for use with multimedia equipment. The broadcast signal 214, or a portion of the broadcast signal, may be stored on the storage area 216a and 218a. A consumer may view the multimedia-content stored on the storage area 216a after the broadcast signal has been received and stored on the storage area 216a. Information pertaining to the multimedia-content, stored on the storage area, is communicated along return communication path 220 and is received at an information collection system 202.

In one embodiment, a scheduler 204 accepts the information from the information collection system 202 and selects multimedia-content that will be broadcast to the consumers from a pool of available multimedia content. The information collected from the consumers may include data on the state of the multimedia-content residing on the storage area. The selection of multimedia-content may be made in the light of the information collected from the consumer. A multimedia-content database/server configures the selected multimedia-content for transmission and may communicate with the information collection system 202 as required through a connector 205. Minimally, the connection 205 is used to communicate the list of available multimedia content to the information collection system 202 such that analysis of the information and data received from 220 is applied to the current list of available multimedia content.

The selected multimedia-content is configured for transmission by a data encapsulation and packetization process and equipment at 208. Other programming content and system information at 210 is multiplexed with the selected multimedia-content at 212 resulting in broadcast signal 214.

The invention provides an infrastructure for scheduling delivery of multimedia content such that the consumer(s) has the ability to access multimedia-content immediately, without having to wait for the particular time the multimedia-content is scheduled to be broadcast. The cycle just described may repeat at a periodic rate, delivering selected multimedia-content to the consumer(s). The periodic rate is flexible and may be chosen as desired. The previous description may be applied to any number of consumers. Thus, the application may be to a single consumer or a plurality of consumers.

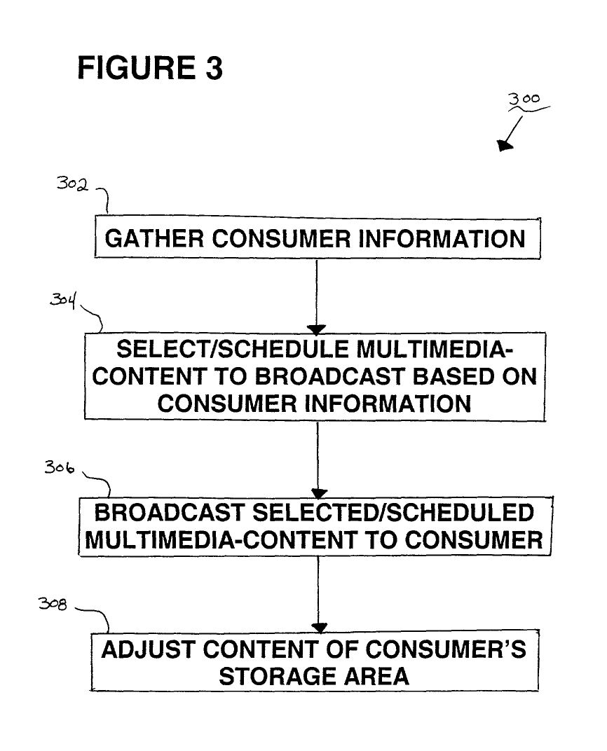

Corresponding to the schematic representation shown in FIG. 2, FIG. 3 embodies four broad processes that may be combined to select and adjust the multimedia-content of the consumer's storage area. Each of these broad processes will subsequently be described in more detail. With reference to FIG. 3, information is gathered from the consumer at block 302. The information may come from a variety of sources. The information would be part of the information that would be used by the scheduler 204 (FIG. 2) to select and schedule the multimedia-content to be broadcast to the consumer(s) at block 304. At block 306 the selected and scheduled multimedia-content is broadcast to the consumer(s). In block 308 the content of the consumer's storage area 216a (FIG. 2) is managed as the multimedia-content is transferred to the storage area from the received broadcast signal.

### Consumer Information

Information gathered from the consumer may come from a variety of sources. For example, the information may be in the form of a report of the consumer's viewing history over a time interval obtained from reading the directory of the storage area 216a (FIG. 2). In another embodiment, as a step in configuring the storage area, the consumer may enter information which becomes the consumer's profile. The consumer's profile may be updated as the consumer's preferences change over time. Thus, the selection of multimedia-concern, content, made by the selector/scheduler 204 (FIG. 2) is able to dynamically alter its selections based on the changing preferences of the consumer.

Information is gathered by return communication path 220 (FIG. 2) and is supplied to the information collection system 202. Information may be gathered in any one of the many ways that are well known in the art. One way to gather the information is by using a dial up modem to establish a connection with the information collection system 202 and then transfer the information over any suitable network such as the Internet, for example. Alternatively, the information could be sent within the portion of the bandwidth assigned for up-link communications from the DTV receiver to the cable television (CATV) provider. The same method of communication may be used with satellite television (SATV) systems that employ an active link from the DTV receiver that allows two-way communication with the SATV provider. Other forms of information gathering may be employed such as a telephone call between the consumer and the CATV or SATV provider as well as communication of consumer information through the mail. The invention is not limited by the means employed to transfer the information to the information collection system.

### Selecting/Scheduling

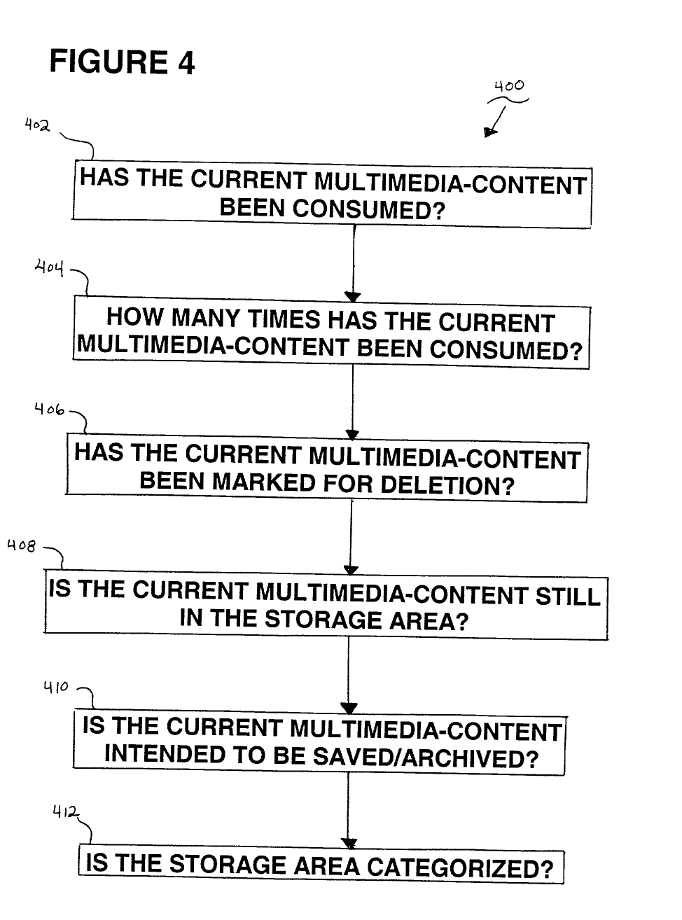

In one embodiment, the process of selecting new multimedia-content to be broadcast may include, as input, a list of current movies that have been introduced in the last week. The list could then be filtered by selection criteria, such as that shown in FIG. 4, resulting in the selection of the multimedia-content that will be broadcast next to the consumers. With reference to FIG. 4, whether the current multimedia-content has been consumed is listed at block 402. Current multimedia-content in this usage refers to the presently existing multimedia-content on the consumer's storage area. Additional selection criteria may include: how many times the current multimedia-content has been consumed (block 404); has the current multimedia-content been marked for deletion (block 406); is the current multimedia-content still in the storage area (block 408); is the current multimedia-content intended to be saved/archived (block 410); and is the storage are a categorized (block 412).

As previously described, the multimedia-content may cover a variety of subject matter. In one embodiment, the multimedia-content refers to movies. Selecting movies may include consideration of the consumer's viewing history containing information on how many times a particular movie was viewed. Other movies that were not viewed could be identified. Movies that were marked to be archived would be noted. Other information could be factored in, such as consumer preferences. With respect to movies, the consumer may be asked to enter data on his or her viewing preferences (from the consumer profile), such as ranking in order of interest; westerns, action, drama, comedy, etc. Other information might include the consumer's interest in “old” movies verses “new” movies. Information on the time the consumer viewed a particular movie could also be gathered. For example, the scheduler may decide, based on consumer information collected over time, that western movies are most likely to be viewed between 9 PM and 11 PM rather than 2 PM to 4 PM. Depending on how often the multimedia-content was updated, the scheduler could use this information to ensure that new western movies were available to the consumer between 9 PM and 11 PM.

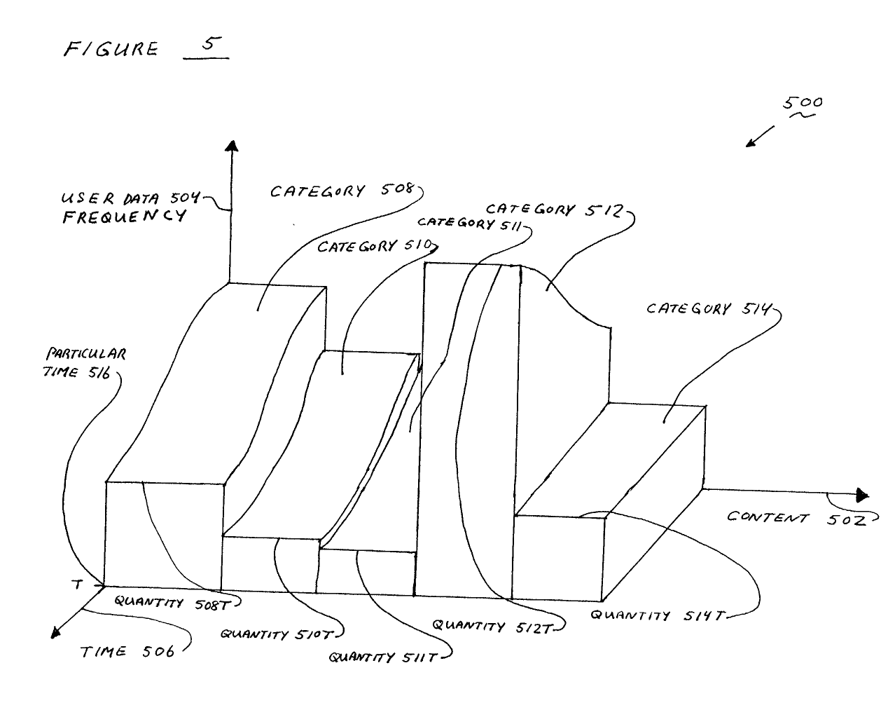

Information collected from the consumer(s) may be used to compile a histogram 500 as shown in FIG. 5. The histogram 500 displays information on the categorized multimedia-content of the consumer's storage area or the aggregate storage area of a plurality of consumers, as a function of time. It is apparent to those of skill in the art that the invention may be implemented at a variety of levels as was previously explained. Therefore, the histogram in FIG. 5 may represent information from a single consumer or a plurality of consumers. With reference to FIG. 5, information from the multimedia-content is depicted at 502 divided into several categories. A category 508, a category 510, a category 511, a category 512 and a category 514 make up the multimedia-content of the storage area. The multimedia-content may change as a function of time. The axis indicating time is depicted by time 506. Each category has a magnitude at a particular time as indicated with user data frequency 504. User data frequency 504 may represent a number of items within a category of multimedia stored on the storage area or it may represent any other aspect of consumer information such as the number of times a particular multimedia-content has been consumed. With application to movies, category 508 could represent western movies and a quantity 508T could represent the number of western movies residing on the storage area at a particular time 516. The scheduler could use the information contained in FIG. 5 to decide to make western movies a greater percentage of the multimedia-content transmitted in the next broadcast, because of a declining number of western movies residing on the storage area and the need to update and refresh this category with new western movies. In a similar way the user data frequency 504 could represent the number of times western movies were watched over a particular time interval 516 and the scheduler could interpret the declining trend shown by the category 508 to arrive at the same decision concerning western movies. The category 510 and the category 511, like the category 508,have declining trends and the same decision could be made, e.g. (increase the percentage of those categories in the next broadcast of multimedia-content). Conversely, the category 512 shows an increasing trend with respect to user data frequency 504, therefore the scheduler could decrease the percentage of this category in the next broadcast of multimedia-content to prevent the popular multimedia content from being replaced by new content. The category 514 has remained at a constant level over the time interval shown; therefore the scheduler could keep the percentage of the category 514 unchanged in the next broadcast. This method of selecting is just one of the many ways the scheduler 202 (FIG. 2) could select multimedia-content intended for the next broadcast, the invention is not limited by the way in which multimedia-content is selected or scheduled.

### Broadcasting Multimedia-content

The invention decouples a consumer's decision and action to consume multimedia-content from the need to allocate bandwidth for transmission of the broadcast in real time. This decoupling is achieved as previously described. When the consumer views multimedia-content on his television for example, the multimedia-content has already been broadcast, received, and transferred to the storage area before the multimedia-content is viewed by the consumers. The selection of multimedia-content occurs in an intelligent way within the invention, based on the gathered consumer information. An advantage of selecting the multimedia-content in this manner is that efficient use of the bandwidth, available for the broadcast signal 214 (FIG. 2), is made by limiting the transmission of the multimedia-content to content that the consumers are likely to be interested in. Efficiency as used in this context refers to multimedia-content actually consumed, divided by the total multimedia-content actually broadcast. Thus, if the entire broadcast of multimedia-content was actually consumed, the efficiency would be one hundred percent, and if none of the multimedia-content broadcast were consumed, the efficiency would be zero percent. By using consumer information as previously described, a multimedia-content provider is able to tailor their service and not waste bandwidth, or the consumer's time, by broadcasting content that is not of interest to the consumer.

Broadcast signal 214 (FIG. 2) may carry the selected multimedia-content according to a variety of methods. In one embodiment, the multimedia-content may be sent on a substantially dedicated channel using a constant data rate. System architecture that sets aside one or more separate channels for the multimedia-content will result in a rapid transfer of the multimedia-content to the storage area 21ba and 218a.

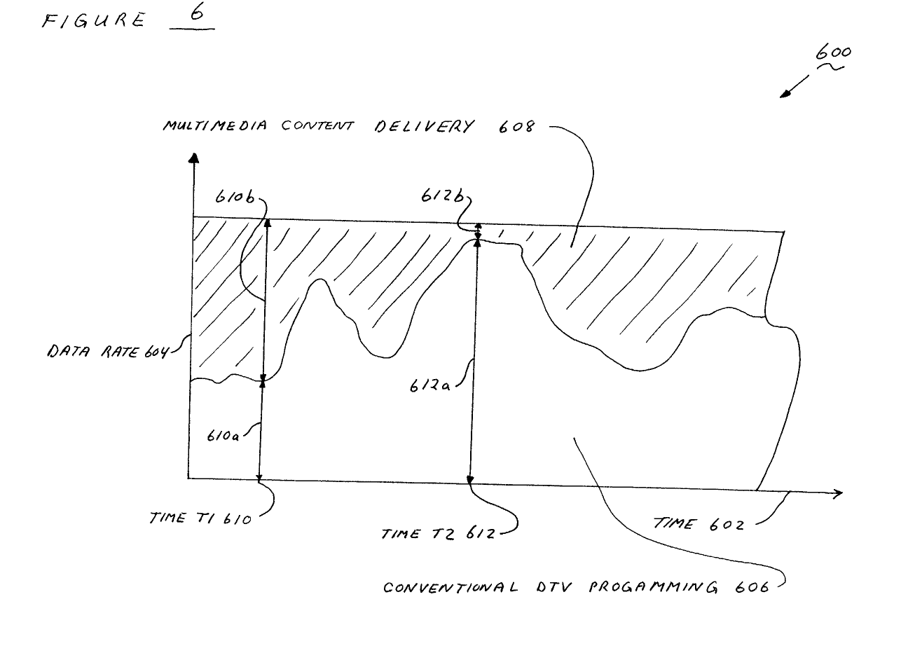

Alternatively, the multimedia-content may be multiplexed onto existing channels and sent at a variable data rate using a technique known in the art as opportunistic insertion of data (OID). With reference to FIG. 6, OID is graphically shown as applied to a television broadcast 600. A horizontal axis is labeled time 602 and is meant to convey the distribution of data in the television broadcast as a function of time. A data rate 604 shows the instantaneous transfer rate of data at a given time. A conventional DTV programming 606 is shown as the solid region and the multimedia-content according to the invention is shown as a multimedia-content delivery 608. Two individual points in time are marked as a time T1 610 and a time T2 612. At the time T1 610, a 610a data rate represents the data rate required to transmit the conventional DTV programming 606. A 610b data rate represents the data rate available for the transmission of the multimedia-content delivery 608. At the time T2 612, a lower data rate 612b is available for the multimedia-content delivery 608 because of the greater data rate required by the conventional DTV programming 606 represented by a data rate 612a. Transmission of the multimedia-content delivery 608 proceeds as described according to a variable data rate using OID. By necessity, variable data rate transmission requires more time to transmit the multimedia-content delivery 608 than would be required by constant data rate transmission using substantially dedicated channels.

The multimedia-content, indicated as the multimedia-content delivery 608 may be configured according to any of the standards used in the art. One such standard is the Moving Pictures Experts Group (MPEG) standard for video data. Therefore the multimedia-content delivery 608 can be a simultaneous transmission of the plurality of multimedia-content files selected to make up the multimedia-content delivery 608. Alternatively, multimedia-content may be configured in a serial or sequential format. For example, a plurality of movies may be transmitted one after the other.

Efficient use of the available bandwidth is achieved with the methods described above for transmission of the multimedia-content. The methods are flexible and can be adjusted by the multimedia-content provider to achieve a low or high data rate as desired.

### Managing the Multimedia-content on the Storage Area

Many methods of managing the multimedia-content on the storage area are possible. In one embodiment, multimedia-content management may be based on a set of predetermined rules that have been selected by the consumer. At the most basic level, an embodiment with only one rule could allow the new multimedia-content to be added to the old multimedia-content until the storage area was full, at which time the new multimedia-content could overwrite the oldest of the stored multimedia-content.

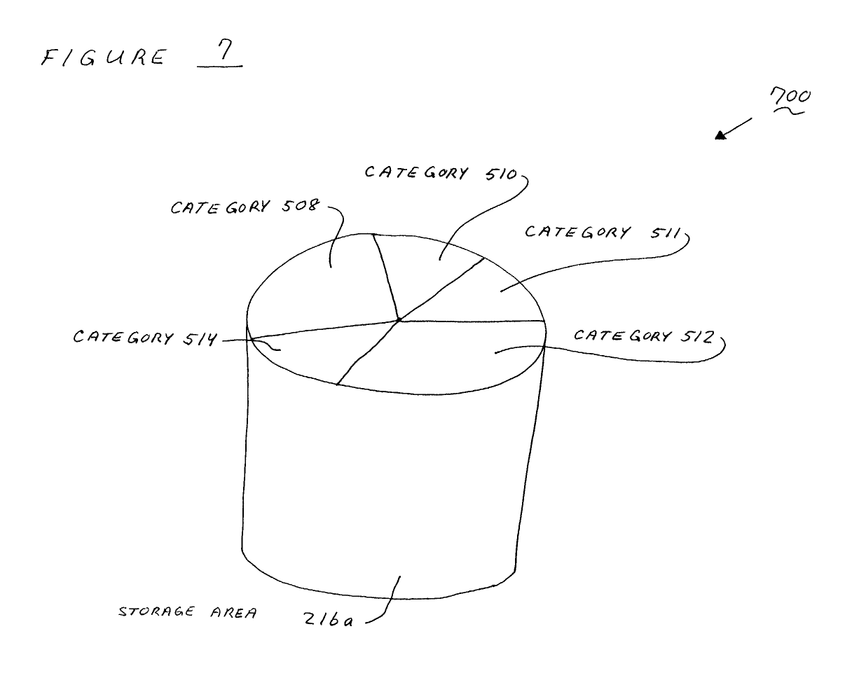

As previously described, the storage area may be categorized. The categories may be allocated by the consumer according to criteria such as fifty percent of the storage area is set aside for movies, twenty five percent is set aside for history subject matter, and fifteen percent is set aside for science subject matter, five percent is set aside for audio, and five percent is set aside for data, etc. or the entire storage area may be set aside for one subject. FIG. 7 shows a storage area for multimedia-content that has been categorized 700. With reference to FIG. 7, the categories correspond to the five categories previously described in FIG. 5, the categories 508 through 514. The storage area could be the one shown in FIG. 2 as the storage area 216a. The storage area 216a may be located in a variety of places; it need not be located proximate to DTV receiver 216. For example, storage area 21 6a could be a virtual storage area accessed across a network residing in a location far away from DTV receiver 216 or close to DTV receiver 216. Storage area 21 6a is shown located as it is in FIG. 2 merely for convenience.

One management example using a simple two rule set applied to the multimedia-content of a categorized storage area could be as follows:

1) keep only three items in a category at any one time; and

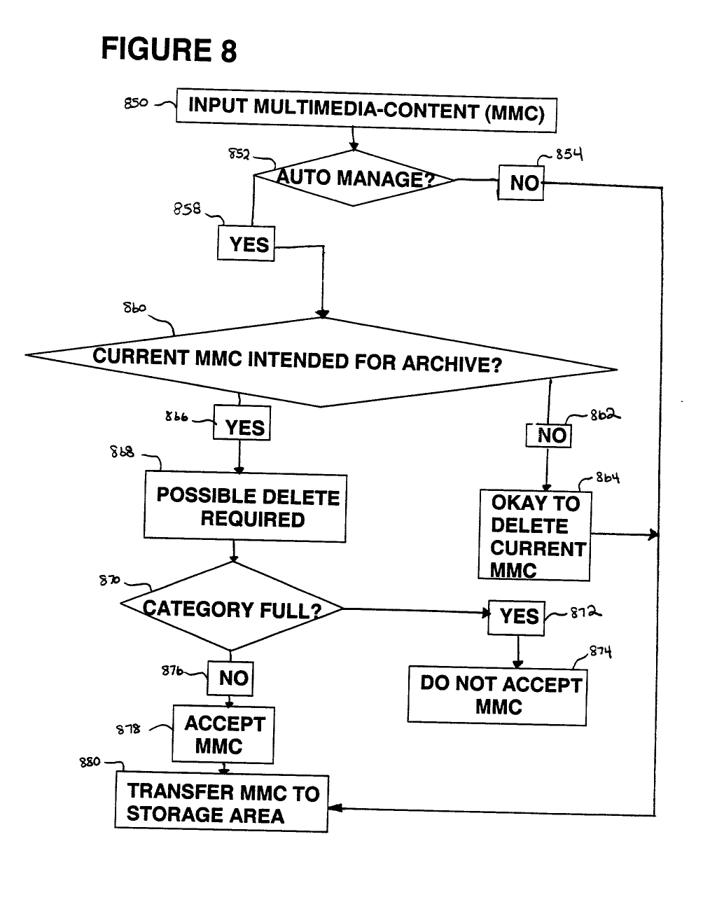

2) do not erase items that have been tagged for archiving. Many methods of managing multimedia-content are anticipated. The simple two rule set described above could be implemented as shown within the flow diagram of FIG. 8.

The following description is applicable to a computer-operated system for managing the multimedia-content on the consumer's storage area. With reference to FIG. 8, multimedia-content is input to the storage area at 850. If the consumer has chosen to allow the multimedia-content provider to manage the content on his storage area a control would be set to direct flow out of an auto-manage block 852 to a block 858. If the consumer had chosen to manage the storage area himself control would be directed to a block 854 resulting in the transfer of the multimedia-content to the storage area at a block 880.

Returning to the case where the consumer has chosen to allow the storage area to be managed automatically, tags on the contents of the multimedia-content already on the storage area (old multimedia-content) are checked at a block 860 to see if any of the items are tagged for archiving. If none of the old multimedia-content is tagged for archiving, control flows to a block 862 and the new multimedia-content is transferred to the storage area in which case the old multimedia-content may be deleted at a block 880.

Returning to the case where old multimedia-content has been tagged for archiving at block 866 a possible delete of old multimedia-content may be required or indicated at a block 868. The number of items in a category is checked at a block 870. If there are less than three items in the category, control is transferred to a block 876. The new multimedia-content is accepted at a block 878 and the new multimedia-content is transferred to the storage area at a block 880. If there are three items already existing in the category and one is tagged for archiving the older of the two items is overwritten by the new multimedia-content.

Possibly all three entries in the category are tagged for archiving, in this case control is transferred to a block 872 and none of the new multimedia-content in the category is accepted as shown at a block 874.

It is anticipated that management of the multimedia-content storage area may proceed under many policies. The examples described above are a small example of the policies that may be employed by those of skill in the art within the scope of the invention.

### Customized Content For the Consumer

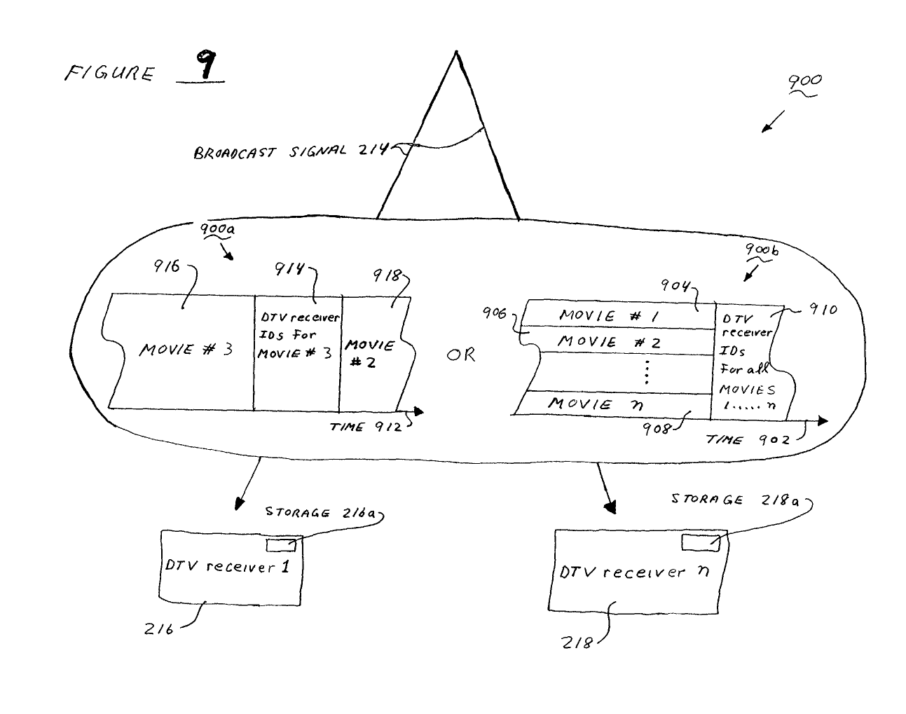

As was previously described, the concepts embodied in this invention may be employed at a high level to a plurality of consumers or the invention may be employed on an individual consumer basis. As an example, a DTV multimedia-content service provider may be supplying individualized multimedia-content that has been tailored to each consumer. There are many ways of configuring the multimedia-content for transmission. FIG. 9 displays two ways of configuring a transmission of the multimedia-content that enables the multimedia-content to be customized for each consumer individually. In one embodiment, the configuration can be done such that the multimedia content is scrambled and a scrambling method or a scrambling key that is linked to the receiver identification is used to unscramble the multimedia-content intended for the particular receiver. With reference to FIG. 9, broadcast signal 214 may be configured with movies as the multimedia-content that are formatted consecutively in time as shown in 900a (a serial format) or the broadcast signal 214 may be formatted such that the movies are formatted parallel in time, as shown at 900b (a parallel format).

In the serial format 900a, time is indicated at time 912, movie #3 is indicated at 916. A list of DTV receiver identifications (IDs) scheduled to receive movie #3 914 precedes movie #3 916 in the broadcast. Preceding the list of DTV receivers IDs 914 is movie #2 and preceding movie #2 would be a list of DTV receiver IDs scheduled to receive movie #2 (not shown). In this manner, DTV receiver 216 would receive movie #3 if the ID for DTV receiver 216 was in the list of DTV receiver IDs for movie #3 914. If DTV receiver 216 was not in the list of DTV receiver IDs for movie #3 914 then DTV receiver 216 would not receive movie #3. For example, DTV receiver 218 may not be in the list of DTV receiver IDs scheduled to receive movie #3, but instead may be in the list of DTV receiver IDs scheduled to receive movie #2, therefore movie #2 would be received and transferred to the storage area associated with DTV receiver 218.

An alternative parallel format for the broadcast signal 214 could be configured as shown in 900b. An increase in time is shown as time 902. A movie #1 904, a movie #2 906 up to a movie n 908 are arranged in a parallel format. Preceding the movies 904 through 908 is a list of DTV receiver IDs for all the movies 904 through 908. The DTV receivers would receive and transfer, to their respective storage areas, the particular movies that were individually scheduled for each receiver. As previously discussed the MPEG standard may be used to configure the broadcast signal 214 as well as any of the other standards that well known in the art.

Thus, a novel multimedia-content selection methodology is disclosed which is based on consumer information. Although the invention is described herein with reference to specific preferred embodiments, many modifications therein will readily occur to those of ordinary skill in the art. Accordingly, all such variations and modifications are included within the intended scope of the invention as defined by the following claims.

What is claimed:

1. A method comprising:
receiving information obtained from at least one of a consumer and a storage area; and
selecting, substantially automatically, multimedia-content to be broadcast to the consumer based on said receiving.

2. The method of claim 1, wherein a selection of the multimedia-content is made contemporaneous with the information obtained from at least one of the consumer and the storage area.

3. The method of claim 1, wherein the multimedia-content is at least one of video, audio, and data.

4. The method of claim 1, further comprising scheduling the multimedia-content to be broadcast to the consumer based on said selecting.

5. The method of claim 4, wherein said scheduling is based on criteria.

6. The method of claim 5, wherein the criteria includes consideration of at least one of; whether the multimedia-content has been consumed yet; how many times the multimedia-content has been consumed; whether the multimedia-content has been deleted or tagged for deletion; if the multimedia-content is still in the storage area; whether the multimedia-content is intended to be saved/archived; and whether the storage area is categorized.

7. The method of claim 1, wherein said receiving is accomplished with at least one of a telephone, a dial-up modem, a cable television vision communication, a network, the Internet, and a wireless communication.

8. A computer readable medium containing executable program instructions, which when executed by a data processing system, cause the data processing system to perform the steps comprising selecting substantially automatically, multimedia-content to be broadcast to a consumer, based on information obtained from at least one of the consumers and a storage area.

9. The computer readable medium of claim 8, further comprising scheduling multimedia-content to be broadcast to the consumer based on said selecting.

10. The computer readable medium of claim 8, further comprising receiving the information from at least one of the consumer and the storage area.

11. A method comprising:
receiving a selection of multimedia content; and
broadcasting the selection of the multimedia-content to a consumer, wherein the selection is based on information obtained from at least one of the consumer and a storage area.

12. The method of claim 11, wherein the selection of the multimedia-content is made contemporaneous with the information obtained from the consumer.

13. The method of claim 11, wherein said broadcasting is accomplished using opportunistic insertion of data.

14. The method of claim 11, wherein said broadcasting is accomplished with a substantially dedicated channel having a fixed transmission bandwidth.

15. The method of claim 11, wherein the multimedia-content is at least one of video, audio, and data.

16. A method comprising:
transferring multimedia content to a storage area, accessible to a consumer's television system; and
managing the multimedia-content stored in the storage area.

17. The method of claim 16, wherein the multimedia-content is at least one of video, audio, and data.

18. The method of claim 16, wherein said managing is based on a policy.

19. The method of claim 18, wherein the policy includes consideration of at least one of; whether the multimedia-content has been consumed yet; how many times the multimedia-content has been consumed; whether the multimedia-content has been deleted or tagged for deletion; if the multimedia-content is still in the storage area; whether the multimedia-content is intended to be saved/archived; and whether the storage area is categorized.

20. A computer readable medium containing executable program instructions, which when executed by a data processing system, cause the data processing system to perform the steps comprising managing multimedia-content stored in a storage area accessible to a consumer's digital television system.

21. The computer readable medium of claim 20, wherein said managing is based on a policy.

22. The computer readable medium of claim 20, wherein the multimedia-content is at least one of video, audio, and data.

23. An apparatus comprising:
a digital television receiver; and
a storage area to store multimedia-content;
wherein the multimedia-content is selected based on information obtained from at least one of a consumer and said storage area.

24. The apparatus of claim 23, wherein the multimedia-content is selected contemporaneously with the information obtained from at least one of the consumer and said storage area.

25. The apparatus of claim 23, wherein the multimedia-content is at least one of video, audio, and data.

26. An apparatus comprising:
a multimedia-content selector to select multimedia-content, substantially automatically, to be broadcast to a consumer, based on information obtained from at least one of the consumer and a storage area.

27. The apparatus of claim 26, further comprising:
a multimedia content scheduler, configured to communicate with said multimedia-content selector, to schedule the multimedia-content to be broadcast to the consumer.

28. The apparatus of claim 26, further comprising:
a processor configured to receive the information and execute instructions that select the multimedia-content to be broadcast to the consumer; and
a storage area configured to allow communication with said processor.

29. The apparatus of claim 26, further comprising:
a multimedia-content data base server, to store new multimedia-content, some of which is selected to be broadcast to the consumer.
